(19) United States
(12) Patent Application Publication
(10) Pub. No.: US 2002/0083291 A1
(43) Pub. Date: Jun. 27, 2002

(54) Nonvolatile semiconductor memory

(75) Inventor: Yoshimasa Yoshimura, Tokyo (JP)

Correspondence Address: MCDERMOTT, WILL & EMERY, 600 13th Street, N.W., WASHINGTON, DC, 20005-3096, US

(73) Assignee: MITSUBISHI DENKI KABUSHIKI KAISHA

(21) Appl. No.: 09/924,452

(22) Filed: Aug. 9, 2001

(30) Foreign Application Priority Data
Dec. 26, 2000 (JP) 2000-394502

(51) Int. Cl. G06F 12/00

(52) U.S. Cl. 711/202

(57) ABSTRACT

Nonvolatile semiconductor memory has simple user interface including defective sector management. Nonvolatile table memory stores an address conversion table for converting an externally applied logical sector address to a physical sector address. An address decoder outputs a specific selection signal corresponding to a physical sector address output from the table memory. The storage area of the memory matrix is divided into a plurality of sectors. The memory matrix interfaces with a data register for reading data loaded therein as necessary. The address conversion table of the table memory is read according to logical sector address input, and a physical sector address corresponding to the logical sector address is output to the address decoder.

### BACKGROUND OF THE INVENTION

The present invention relates to nonvolatile semiconductor memory that is rewritable read-only memory.

With nonvolatile semiconductor memory (referred to below as simply “nonvolatile memory”) such as commonly used for both external storage and main memory in notebook computers, the data storage area is divided into plural sectors, data such as program data and table data is stored to sectors corresponding to specific addresses, and rewriting of the contents is performed by sector. While it is desirable for erase and reading/writing operations to be completed normally in all sectors, it is in practice difficult to achieve nonvolatile memory in which all sectors function normally because of defective sectors present either initially or occurring over time. The number of defective sectors also increases as nonvolatile memory capacity increases.

One known method for handling such defective sectors is to refer a logical-physical address conversion table, which is compiled and managed by an external controller, and read addresses assigned to the nonvolatile memory. FIG. 6 is a schematic diagram of a control system for such nonvolatile memory. The external controller 51 of this control system first refers table memory 52, which stores the logical-physical address conversion table, to fetch the data for a specific address, and applies this address to nonvolatile memory 60 for address conversion. The address applied to nonvolatile memory 60 is first input to address decoder 61 and decoded to a selection signal. The selection signal is then input to memory matrix 62. Memory matrix 62 interfaces with data register 63 for reading data loaded therein.

Distribution and use of this type of nonvolatile memory control method is difficult for both cost and technical reasons because the memory user must prepare hardware such as a controller and peripheral circuitry and corresponding control software separately from the memory, and must be able to capably use this hardware and software.

It is therefore an object of the present invention to provide nonvolatile semiconductor memory whereby a user interface including defective sector management can be easily accomplished without requiring such hardware as the controller and peripheral circuitry and corresponding control software.

### SUMMARY OF THE INVENTION

To achieve this object, in an aspect of the present invention, there is provided a nonvolatile semiconductor memory in which data writing, reading, and erasing are perfromed by specific sectors, said nonvolatile semiconductor memory comprising: nonvolatile table memory constituting an address conversion table for converting an externally applied logical sector address to a physical sector address; an address decoder for outputting a specific selection signal corresponding to the physical sector address output from the table memory; a memory matrix of which the storage area is divided into a plurality of sectors; and a data register which interfaces with said memory matrix so that data loaded therein is read as necessary. The address conversion table of the table memory is read according to logical sector address input, and a physical sector address corresponding to the logical sector address is output to the address decoder.

Further preferably, the nonvolatile semiconductor memory additionally comprises a controller which is connected to said constituent elements and can control memory writing, reading, and erasing, and the memory matrix comprises a plurality of substitute sectors separate from the normal sectors. The controller rerwrites address conversion table content to a physical sector address corresponding to a substitute sector, when writing to a sector corresponding to a physical sector address obtained from the address conversion table produces an error, and writes again to the sector corresponding to the new physical sector address, and if an error occurs again repeats this process of substituting and writing a substitute sector until sector writing is normally accomplished.

Yet further preferably, the memory matrix is controlled using at least four threshold values, and the table memory is controlled using two threshold values.

It should be noted that Japanese Patent Laid-open Publication 2000-122935 discloses technology whereby substitute sectors are provided in nonvolatile memory, and addresses read from an address conversion table are input directly to memory, but differs from the present invention in that defective sector address information pre-stored in nonvolatile memory is copied to a RAM table by an external processor.

Furthermore, Japanese Patent Laid-open Publication 62-226500 discloses technology for providing substitute sectors in memory and inputting an address read from an EXOR address conversion table directly to memory. This differs from the present invention, however, in that addresses to defective sectors are scrambled, and in conjunction therewith addresses to sectors unrelated to the defective sectors are also changed.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a schematic block diagram showing the configuration of nonvolatile semiconductor memory according to a first preferred embodiment of the present invention;

FIG. 2 shows the relationship between memory matrix sectors and data stored to the address area of table memory in nonvolatile semiconductor memory according to a first embodiment of the present invention;

FIG. 3 is a schematic block diagram showing the configuration of nonvolatile semiconductor memory according to a second preferred embodiment of the present invention;

FIG. 4 shows the relationship between normal sectors and replacement sectors in the memory matrix and data stored to the address area of table memory in nonvolatile semiconductor memory according to a second embodiment of the present invention;

FIG. 5 is a flow chart of a management method for nonvolatile semiconductor memory according to the second embodiment of the present invention; and

FIG. 6 shows a schematic block diagram of nonvolatile semiconductor memory according to the related art.

### DESCRIPTION OF THE PREFERRED EMBODIMENTS

The preferred embodiments of the present invention are described below with reference to the accompanying figures.

### First Embodiment

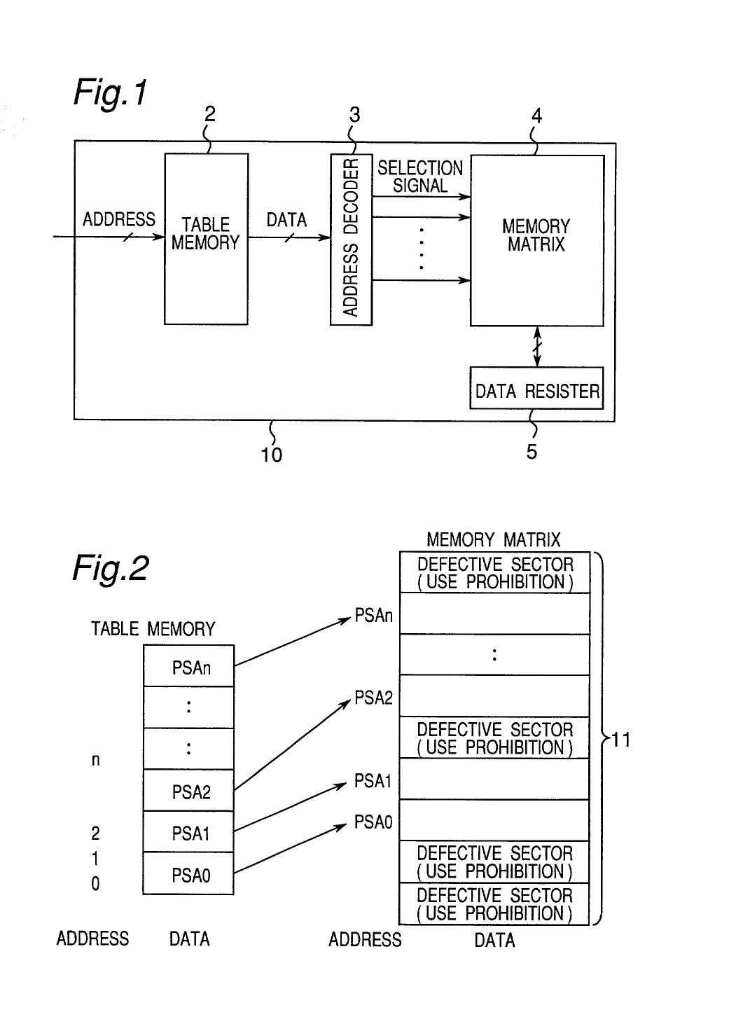

FIG. 1 is a schematic block diagram showing the configuration of nonvolatile memory according to a first preferred embodiment of the present invention. This nonvolatile memory 10 comprises table memory 2, address decoder 3, memory matrix 4, and data register 5. Table memory 2 is nonvolatile memory storing a logical-physical address conversion table for converting an input logical sector address to a physical sector address. Address decoder 3 outputs a specific selection signal corresponding to a physical sector address output from table memory 2. Memory matrix 4 is nonvolatile memory of which the storage area is divided into plural sectors. Memory matrix 4 interfaces with data register 5 for reading data loaded therein.

With nonvolatile memory 10 thus comprised an input logical sector address is first applied to table memory 2. Data stored to the address area corresponding to the input logical sector address is then read and output as a physical sector address to address decoder 3. Output to address decoder 3 is enabled and performed only when the sector in memory matrix 4 corresponding to the output physical sector address is normal. The address decoder 3 then selects the sector in memory matrix 4 corresponding to the input data, and enables access to that sector. Memory matrix 4 interfaces with data register 5 for reading data loaded therein as necessary.

FIG. 2 shows the relationship between data stored to the address area of table memory 2 and corresponding sectors in memory matrix 4. Physical sector address data PSA0, PSA1, PSA2, . . . PSAn is stored to each address area in table memory 2. Physical sector address data PSA0, PSA1, PSA2, . . . PSAn correspond to the sectors 11 constituting memory matrix 4. In this first embodiment of the invention the content of table memory 2 is comprised so that the physical sector address data corresponds to normal sectors while avoiding defective sectors distributed randomly in the memory matrix 4. This means that a normal sector always corresponds to addresses continuously input from an external device and there are no apparent defective sectors.

It is therefore possible for nonvolatile memory 10 according to this first embodiment to interface with other devices without requiring such hardware as a controller and peripheral circuitry and corresponding control software, and without the user being aware of defective sectors.

An alternative embodiment of the present invention is described next below. Note that like parts are referred by like reference numeral, and further description thereof is omitted below.

### Second Embodiment

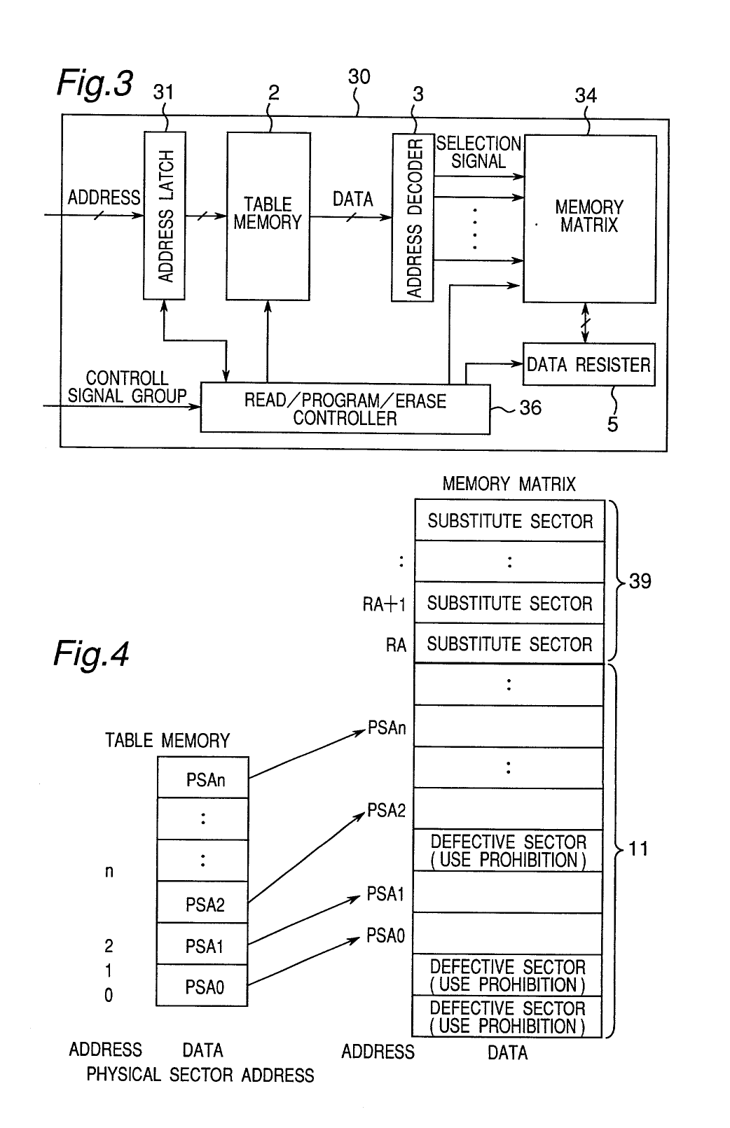

FIG. 3 is a schematic block diagram showing the configuration of nonvolatile semiconductor memory according to a second embodiment of the present invention. To handle defective sectors occurring over time, this second embodiment of the invention provides substitute sectors in the memory matrix, and, when a defective sector is detected, replaces the defective sector with one of these substitute sectors. This nonvolatile memory 30 comprises table memory 2, address decoder 3, memory matrix 34, data register 5, address latch 31, and read/program/erase controller 36.

Address latch 31 holds an output state for a particular address input until there is a next address input, and is disposed before table memory 2. The address output from address latch 31 is input to table memory 2. The read/program/erase controller 36 controls the various components based on a control signal group input from an external device, and is connected by way of control buses 36a, 36b, 36c, 36d to address latch 31, table memory 2, memory matrix 34, and data register 5.

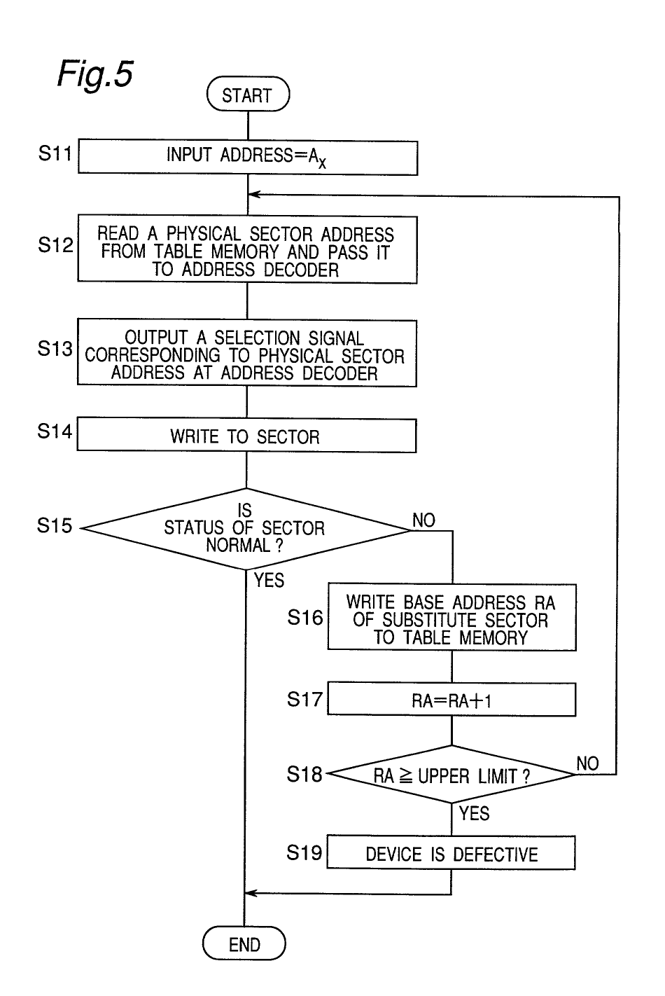

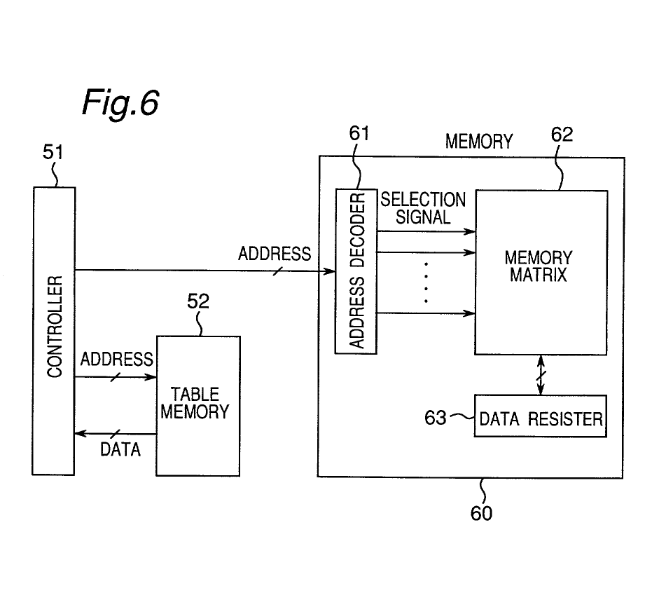

A plurality of substitute sectors 39 is disposed contiguously to normal sectors 11 in a predetermined area of memory matrix 34. FIG. 4 shows the relationship between data stored to the address area of table memory 2 and the normal sectors 11 and substitute sectors 39 in memory matrix 34. The plural substitute sectors 39 correspond to addresses RA, RA+1, RA+2, . . . RA+m (where m is the number of substitute sectors 39 minus 1).

Program operation of nonvolatile memory 30 is described next with reference to the flow chart in FIG. 5. When address Ax is input through address latch 31 in conjunction with the start of operation (S11), the physical sector address for the input address Ax is read from table memory 2 and passed to address decoder 3 (S12). The sector in memory matrix 34 corresponding to the physical sector address is then selected by address decoder 3, which outputs the selection signal (S13).

A writing operation to the selected sector in memory matrix 34 is then performed (S14). The status of the written sector is then checked (S15). If the sector status is normal (S15 returns yes), the process ends because it is considered that writing was normal. However, if S15 returns no, a writing error is known to have occurred. The previously stored base address RA of substitute sector 39 is then written to address Ax in table memory 2 (S16). Note that this base address PA is the address of the first unused substitute sector 39. Address RA is then immediately incremented to RA+1 (S17).

Whether RA is greater than an upper limit, which corresponds to the number of substitute sectors 39, is then detected (S18). If S18 returns yes, RA exceeds the upper limit because all reserved substitute sectors 39 have been used, and the device is considered defective. Further processing therefore ends. However, if S18 returns no, the procedure loops back to S12 and writing continues in this loop as long as available substitute sectors 39 remain.

It is therefore possible for nonvolatile memory 30 according to this preferred embodiment to interface with other devices without requiring such hardware as a controller and peripheral circuitry and corresponding control software, and without the user being aware of defective sectors. In addition, when defective sectors subsequently occurring, a writing operation can be normally performed by replacing them with reserved substitute sectors to accomplish normal writing.

Nonvolatile memory used as memory matrix 4 or 34 in the above preferred embodiments of the invention can be nonvolatile multivalue memory controlled using at least four threshold values. Japanese Patent Laid-open Publication 9-091971 and M5M29F25611VP memory from Mitsubishi Electric Corp. are exemplary of such nonvolatile multivalue memory.

Furthermore, the nonvolatile memory used for table memory 2 can likewise be nonvolatile multivalue memory manufactured in the same process used for memory matrix 4, 34. By producing both memory units in the same process, manufacturing is easier and the system configuration can be achieved at relatively low cost.

The nonvolatile memory used for table memory 2 can also be conventional memory controlled with two threshold values. Access can be made faster using a two-value controlled table memory 2. Reading from table memory in particular can be accomplished at high speed, and a drop in the overall processing speed can be suppressed, by using a two-value controlled table memory 2 when multivalue memory controlled using at least four threshold values is used for memory matrices 4, 34.

Although the present invention has been described in connection with the preferred embodiments thereof with reference to the accompanying drawings, it is to be noted that various changes and modifications will be apparent to those skilled in the art. Such changes and modifications are to be understood as included within the scope of the present invention as defined by the appended claims, unless they depart therefrom.

What is claimed is:

1. Nonvolatile semiconductor memory in which data writing, reading, and erasing are accomplished in specific sector units, comprising:
a nonvolatile table memory constituting an address conversion table for converting an externally applied logical sector address to a physical sector address;
an address decoder for outputting a specific selection signal corresponding to a physical sector address output from the table memory;
a memory matrix of which the storage area is divided into a plurality of sectors; and
a data register which interfaces with the memory matrix so that data loaded therein is read as necessary;
wherein the address conversion table of the table memory is read according to logical sector address input, and a physical sector address corresponding to the logical sector address is output to the address decoder.

2. Nonvolatile semiconductor memory according to claim 1, further comprising a controller which is connected to said constituent elements and can control memory writing, reading, and erasing, and the memory matrix comprises a plurality of substitute sectors separate from the normal sectors,
wherein the controller rerwrites address conversion table content to a physical sector address corresponding to a substitute sector, when writing to a sector corresponding to a physical sector address obtained from the address conversion table produces an error, and writes again to the sector corresponding to the new physical sector address, and if an error occurs again repeats this process of substituting and writing a substitute sector until sector writing is normally accomplished.

3. Nonvolatile semiconductor memory according to claim 1, wherein the memory matrix is controlled using at least four threshold values, and the table memory is controlled using two threshold values.
